(19) United States
(12) Patent Application Publication
(10) Pub. No.: US 2009/0233019 A1
(43) Pub. Date: Sep. 17, 2009

(54) PARTITIONED LAMINATING JACKET

(75) Inventors: Timothy K. Nowack, Chicago, IL (US); Colin Knight, Winnetka, IL (US)

Correspondence Address: MICHAEL BEST & FRIEDRICH LLP, 100 EAST WISCONSIN AVENUE, SUITE 3300, MILWAUKEE, WI, 53202, US

(73) Assignee: ACCO BRANDS USA LLC, Lincolnshire, IL (US)

(21) Appl. No.: 12/046,028

(22) Filed: Mar. 11, 2008

(51) Int. Cl. F16B 5/00; B65D 65/28

(52) U.S. Cl. 428/33; 428/43; 156/253

(57) ABSTRACT

A partitioned laminating jacket includes a first layer, a second layer bondable with the first layer in a laminating machine, and an adhesive between the first layer and the second layer operable to bond the first layer and the second layer in the laminating machine. An intermediate space is defined between the first layer and the second layer. A seam substantially spans the partitioned laminating jacket along a first axis. The first layer and the second layer are bonded along the seam, and the intermediate space is partitioned into a first receiving area and a second receiving area by the seam.

### BACKGROUND

The present invention relates to a laminating jacket, which is used with a laminating machine for laminating objects, such as photos, newspaper clippings, loose leaf paper, posters, index cards, business cards, identification cards, and the like.

### SUMMARY

In one embodiment, the invention provides a partitioned laminating jacket including a first layer, a second layer bondable with the first layer in a laminating machine, and an adhesive between the first layer and the second layer configured to bond the first layer and the second layer in the laminating machine. An intermediate space is defined between the first layer and the second layer. A seam substantially spans the partitioned laminating jacket along a first axis. The first layer and the second layer are bonded along the seam, and the intermediate space is partitioned into a first receiving area and a second receiving area by the seam.

In another embodiment, the invention provides a method of creating laminated objects. A partitioned laminating jacket is provided having a first pre-formed seam extending substantially across the partitioned laminating jacket, the first pre-formed seam at least partially defining a first receiving area and a second receiving area. A first object is inserted into the first receiving area. A second object is inserted into the second receiving area. The partitioned laminating jacket is inserted into a laminating machine to laminate the first and second objects. The first object and a first portion of the partitioned laminating jacket are separated from the second object and a second portion of the partitioned laminating jacket.

Other aspects of the invention will become apparent by consideration of the detailed description and accompanying drawings.

### BRIEF DESCRIPTION OF THE DRAWINGS

FIG. 1 is a perspective view of a partitioned laminating jacket, according to one embodiment of the invention.

FIG. 1A is a detail view of a portion of the partitioned laminating jacket of FIG. 1.

FIG. 2 is a perspective view of first and second layers of the partitioned laminating jacket of FIG. 1.

FIG. 3 is a schematic view of a sealing operation of the layers shown in FIG. 2.

FIG. 4 is a partial side view of a perforator wheel.

FIG. 5 is a perspective view of the partitioned laminating jacket of FIG. 1 after being laminated and having one receiving area detached from the partitioned laminating jacket.

FIG. 6 is a perspective view of a partitioned laminating jacket according to another embodiment of the invention along with an object to be laminated therein.

FIG. 7 is a perspective view of a detached portion of the partitioned laminating jacket of FIG. 6, including the object of FIG. 6, which is laminated therein.

FIG. 8 is a top view of a partitioned laminating jacket, according to yet another embodiment of the invention.

FIG. 9 is a perspective view of the partitioned laminating jacket of FIG. 8 assembled into a three-dimensional laminated piece.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

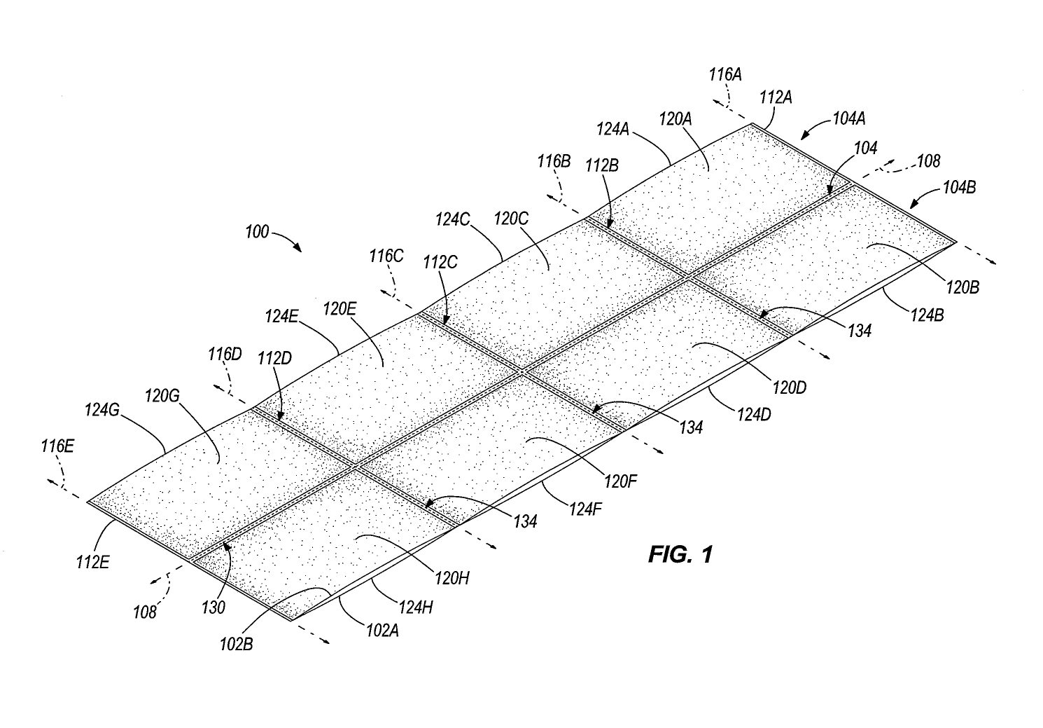

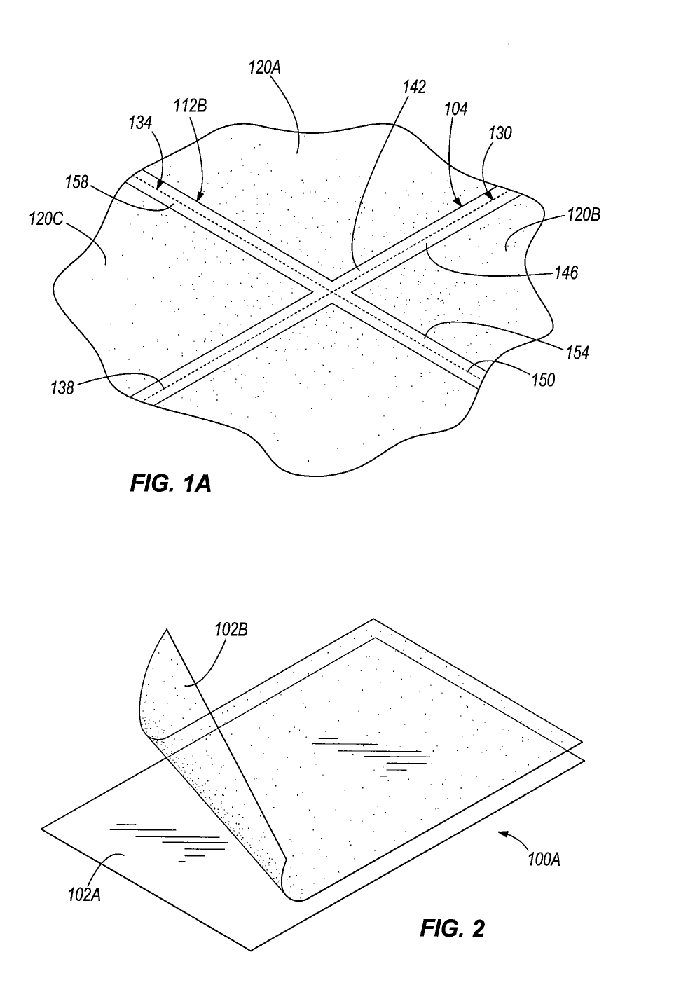

A partitioned laminating jacket 100 including a first layer 102A and a second layer 102B is illustrated in FIG. 1. The partitioned laminating jacket 100 includes a first pre-formed seam 104 extending across and substantially spanning the partitioned laminating jacket 100 along a first axis 108. The first and second layers 102A, 102B are bonded or coupled together along the first pre-formed seam 104 as discussed further below. The first pre-formed seam 104 generally divides the partitioned laminating jacket 100 into two rows 104A, 104B, as described in further detail below. As illustrated in FIG. 1, the rows 104A, 104B can form substantially equal halves of the partitioned laminating jacket 100, but such is not necessary. The partitioned laminating jacket 100 further includes a group of secondary pre-formed seams 112A-E that extend across and substantially span the partitioned laminating jacket 100 along a group of secondary axes 116A-E, respectively. All of the secondary axes 116A-E are substantially parallel to one another and substantially perpendicular to the first axis 108 (of the first pre-formed seam 104). The first and second layers 102A, 102B are bonded or coupled together along each of the secondary pre-formed seams 112A-E as discussed further below. As illustrated in FIG. 1, the secondary pre-formed seams 112A-E are five in number and, in cooperation with the first pre-formed seam 104, collectively define eight separate receiving areas 120A-H, four in each row 104A, 104B.

The receiving areas 120A-H are each defined by a portion of the first pre-formed seam 104 and portions of two adjacent secondary pre-formed seams 112A-E, leaving a single un-sealed edge of each of the receiving areas 120A-H. Respective openings 124A-H are defined along the un-sealed edge of each of the receiving areas 120A-H. Thus, an intermediate space between the first and second layers 102A, 102B defines each respective receiving area 120A-H, and the openings 124A-H provide access to the respective receiving areas 120A-H. As described in further detail below, objects to be laminated can be inserted into the respective receiving areas 120A-H prior to use in a laminating machine (not shown). Objects to be laminated are not limited and include virtually all substantially planar objects of a size equal to the receiving areas 120A-H or smaller. Although FIG. 1 illustrates the receiving areas 120A-H to have substantially equal areas, the partitioned laminating jacket 100 can include two or more receiving areas having substantially unequal areas. Likewise, the relative dimensions of the receiving areas 120A-H are not limited to those illustrated in FIG. 1, nor is the partitioned laminating jacket 100 required to have the exact number of receiving areas 120A-H illustrated and referred to herein.

Each opening 124A-H opens in a direction substantially parallel to the secondary axes 116A-E and away from the first pre-formed seam 104. Therefore, the openings 124A, 124C, 124E, 124G of the first row 104A open in a first direction, and the openings 124B, 124D, 124F, 124H of the second row 104B open in a second direction 180 degrees opposite the first direction. Objects to be laminated are insertable into the respective receiving areas 120A-H in a direction substantially parallel to the secondary axes 116A-E and toward the first pre-formed seam 104.

As illustrated in FIG. 1, a row of perforations 130 extends along the first pre-formed seam 104. The perforations 130 are apertures extending through the first and second layers 102A, 102B of the partitioned laminating jacket 100. Secondary rows of perforations 134 extend along interior ones of the secondary pre-formed seams 112B-D. The perforations 134 of the secondary rows are apertures extending through the first and second layers 102A, 102B of the partitioned laminating jacket 100. FIG. 1A illustrates the perforations 130, 134 along the first and secondary pre-formed seams 104, 112B in more detail.

FIG. 1A is a detail perspective view of a portion of the partitioned laminating jacket 100. As illustrated in FIG. 1A, the perforations 130 along the first pre-formed seam 104 define an edge 138 dividing the first pre-formed seam 104 into a first seam portion 142 and a second seam portion 146. The first seam portion 142 defines a boundary of each of the receiving areas 120A, 120C, 120E, 120G of the first row 104A. The second seam portion 146 defines a boundary of each of the receiving areas 120B, 120D, 120F, 120H of the second row 104B. As described in further detail below, the receiving areas 120A, 120C, 120E, 120G of the first row 104A are separable from the receiving areas 120B, 120D, 120F, 120H of the second row 104B along the edge 138 defined by the perforations 130 through the first pre-formed seam 104.

With further reference to FIG. 1A, the perforations 134 along the secondary pre-formed seam 112B define an edge 150 dividing the secondary pre-formed seam 112B into a first seam portion 154 and a second seam portion 158. The first seam portion 154 defines a boundary of each of the first receiving areas 120A, 120B of the first and second rows 104A, 104B. The second seam portion 158 defines a boundary of each of the receiving areas 120C, 120D immediately adjacent the respective first receiving areas 120A, 120B of the first and second rows 104A, 104B. The additional secondary pre-formed seams 112C, 112D have a similar arrangement as that of the secondary pre-formed seam 112B described just above. As described in further detail below, adjacent receiving areas 120A, 120C, 120E, 120G of the first row 104A are separable from each other along the edges 150 defined by the perforations 134 through the secondary pre-formed seams 112B-D. Likewise, adjacent receiving areas 120B, 120D, 120F, 120H of the second row 104B are separable from each other along the edges 150 defined by the perforations 134 through the secondary pre-formed seams 112B-D.

A method for manufacturing the partitioned laminating jacket 100 and methods for using the partitioned laminating jacket 100 are described below.

As shown in FIG. 2 and generally described above, the partitioned laminating jacket 100 includes a first layer 102A and a second layer 102B. Reference number 100A is used to indicate the loose assembly of the first and second layers 102A, 102B in process of becoming the partitioned laminating jacket 100 illustrated in FIG. 1. The first and second layers 102A, 102B are formed of polyethylene terephthalate (PET, commonly “polyester”) in some embodiments. The first and second layers 102A, 102B have a combined thickness of between about 0.005 inches and about 0.010 inches in some embodiments, of which the first and second layers 102A, 102B can form substantially equal parts.

An adhesive is applied to the second layer 102B on a side that faces the first layer 102A. In some embodiments, adhesive can be applied to a side of the first layer 102A that faces the second layer 102B, or adhesive can be applied to both the first and second layers 102A, 102B on sides that face each other. The adhesive is operable to bond the first and second layers 102A, 102B and/or bond at least one of the first and second layers 102A, 102B to an object between the first and second layers 102A, 102B as described in further detail below. At least one of the first and second layers 102A, 102B is substantially translucent so that an object to be laminated is viewable from the outside when placed inside one of the receiving areas 120A-H. As illustrated in FIG. 2, the second layer 102B is substantially translucent, although it may appear somewhat opaque and/or grainy prior to lamination due to the adhesive. The second layer 102B (including the adhesive) is made substantially transparent when processed in a laminating machine. In some embodiments, the adhesive includes at least one of an ethylene vinyl acetate (EVA) material and a low density polyethylene (LDPE) material. The other of the first and second layers 102A, 102B can be either substantially translucent or substantially opaque, and can be of one or more colors or patterns (for example, to make a decorative matting around an object to be laminated).

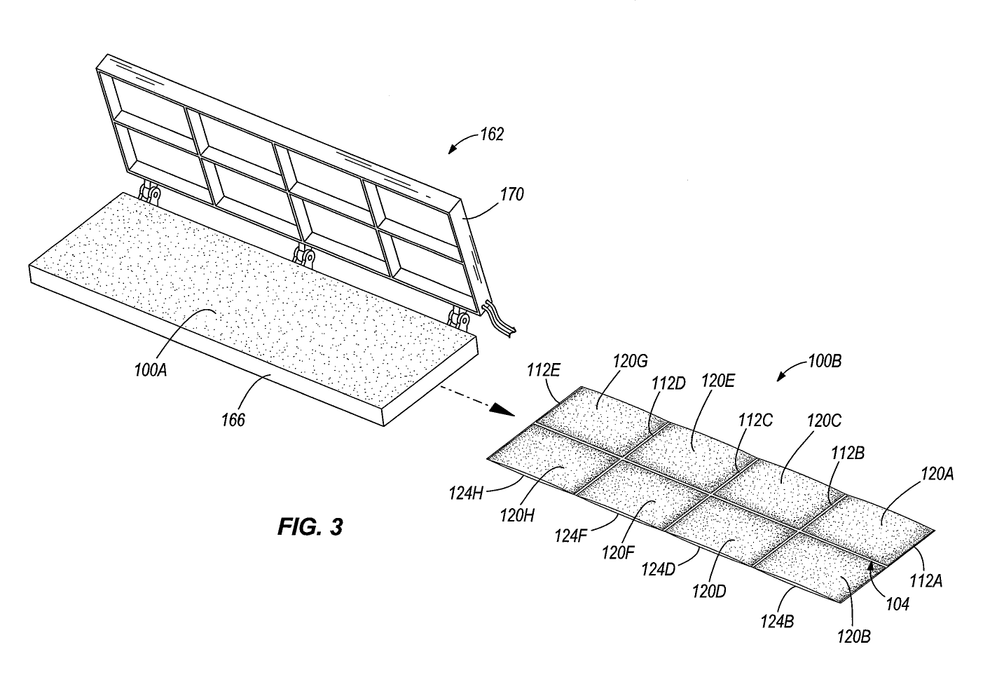

FIG. 3 illustrates the processing of the loose assembly 100A of FIG. 2 into a laminating jacket 100B in process of becoming the partitioned laminating jacket 100 illustrated in FIG. 1. The loose assembly 100A is inserted into a sealing machine or bar sealer 162. The bar sealer 162 includes a base portion 166 and a movable upper portion 170 having a grid corresponding to the arrangement of the first and secondary pre-formed seams 104, 112A-E. As used herein, “pre-formed seam” refers to a seam (a coupling or bonding of the first and second layers 102A, 102B) that is formed prior to the use of the partitioned laminating jacket 100 with a laminating machine (not shown) and, in the most common instances, prior to the packaging and the sale of the partitioned laminating jacket 100 to a consumer.

The bar sealer 162 can include heaters, such as electrically-powered heaters, in at least one of the base portion 166 and the movable upper portion 170. The movable upper portion 170 is moved into contact with the loose assembly 100A so that the first and second layers 102A, 102B are bonded by heating the adhesive according to the layout of the grid. The bar sealer 162 can additionally or alternately be configured to apply pressure in order to activate the adhesive and bond the first and second layers 102A, 102B according to the arrangement of the first and secondary preformed seams 104, 112A-E. After the first and secondary pre-formed seams 104, 112A-E are made by the bar sealer 162, the in-process laminating jacket 100B includes the first and second rows 104A, 104B of receiving areas 120A-H and the respective openings 124A-H. The in-process laminating jacket 100B shown in FIG. 3 does not include any of the perforations 130, 134. In some embodiments, a multi-purpose sealer and perforator can be used to form the first and second pre-formed seams 104, 112A-E and the perforations 130, 134 essentially at once, or at least without transferring the in-process laminating jacket 100B between the sealing and perforating operations.

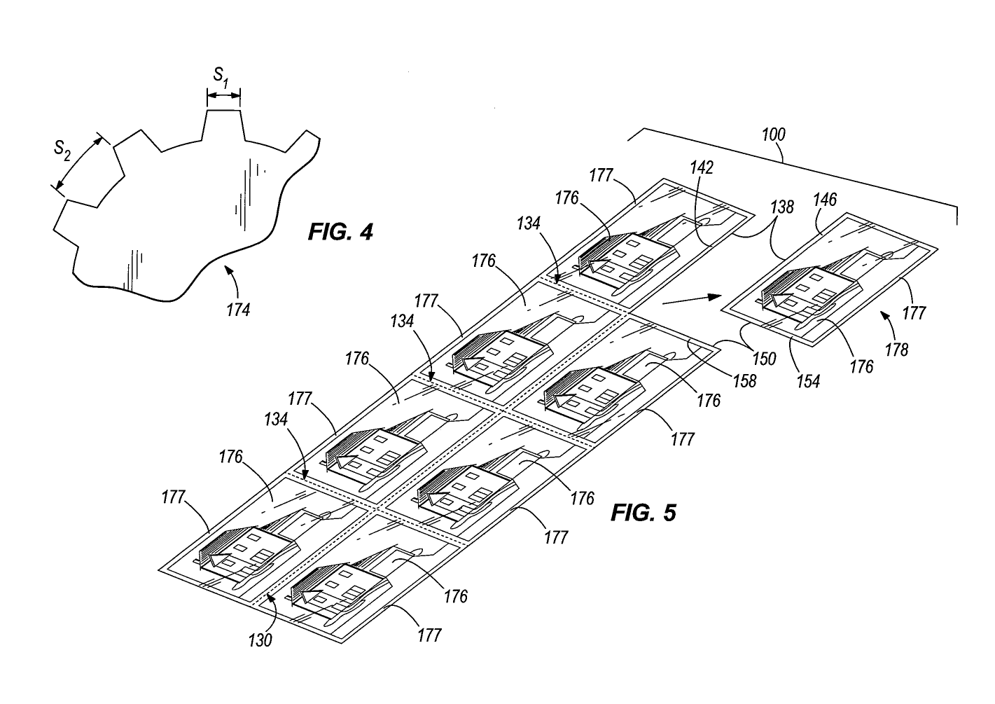

FIG. 4 illustrates a perforator wheel 174 used to create the perforations 130, 134 with a predetermined aperture length S1 and spacing S2. The aperture length S1 and spacing S2 are configured to provide the partitioned laminating jacket 100 as a single unit for receiving one or more objects to be laminated and to allow simple tool-free separation of the receiving areas 120A-H along the edges 138, 150. The first and second seam portions 142, 146 of the first pre-formed seam 104 are left intact after separation along the edge 138. Likewise, the first and second portions 154, 158 of the secondary pre-formed seams 112B-D are left intact after separation along the edges 150. The perforations 130, 134 are configured to allow separation of the respective receiving areas 120A-H with controlled tearing only between individual apertures of the perforations 130, 134 so that the receiving areas 120A-H are not substantially degraded. For example, a tear will not propagate away from the perforations 130, 134 into the receiving areas 120A-H. Furthermore, separation at the perforations 130, 134 does not readily allow separation of the first and second layers 102A, 102B at the respective edges 138, 150.

FIG. 5 illustrates the partitioned laminating jacket 100 after laminating in a laminating machine. The partitioned laminating jacket 100 is shown with an object 176 (i.e., photo) in each of the receiving areas 120A-H. In one method of the invention, the objects 176 are inserted into each of the receiving areas 120A-H before insertion of the entire partitioned laminating jacket 100 into a laminating machine. The laminating machine seals closed the openings 124A-H and closely bonds together the first layer 102A, the objects 176, and the second layer 102B by the adhesive, which is activated by at least one of heat and pressure in the laminating machine. In addition to the first and secondary pre-formed seams 104, 112A-E, a final seam 177 is formed substantially parallel to and opposite the edge 138 by closing the openings 124A-H and bonding the first and second layers 102A, 102B with the laminating machine.

Once processed through the laminating machine, the perforations 130, 134 facilitate the separation of the individual receiving areas 120A-H from the partitioned laminating jacket 100 along the respective edges 138, 150. Therefore, each separated object 176 (along with the respective portion of the partitioned laminating jacket 100) becomes a standalone laminated piece 178 having four sealed edges, two or three of which are formed when the partitioned laminating jacket 100 is split along the perforations 130, 134. As described above, the separating of the first and secondary pre-formed seams 104, 112B-D into parts does not negatively affect the quality of the bond in the region of the first and secondary pre-formed seams 104, 112B-D.

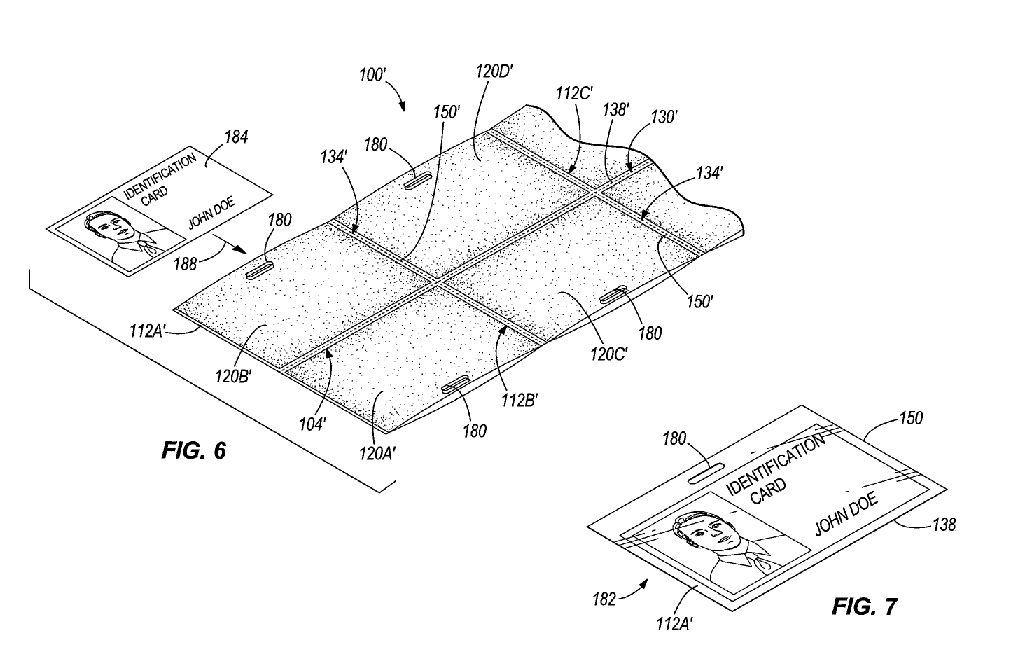

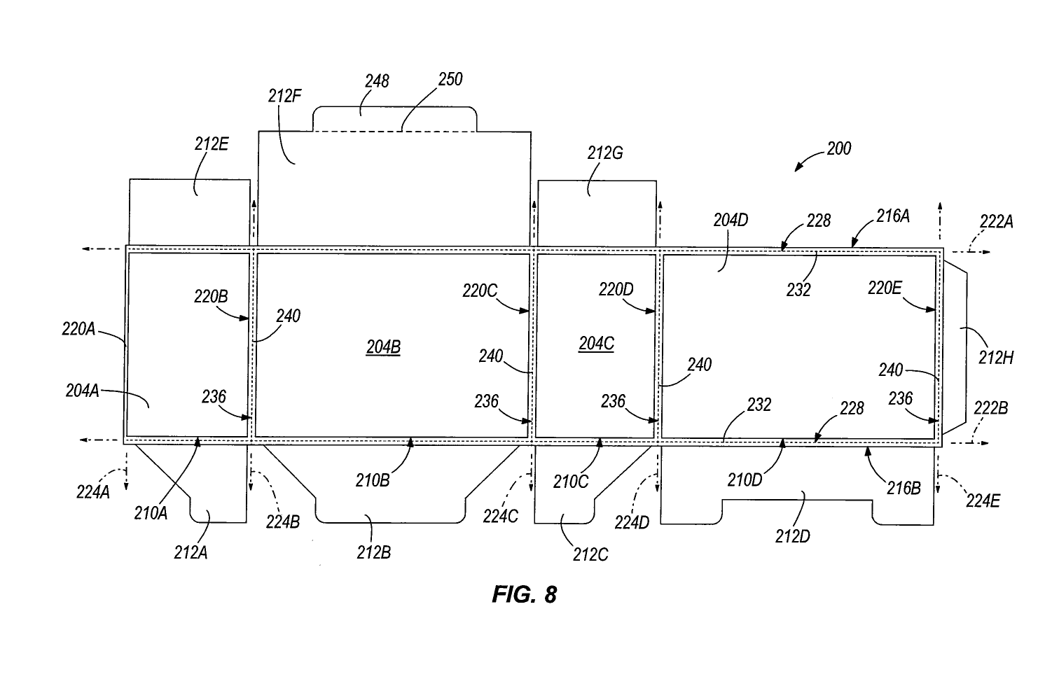

FIGS. 6 and 7 illustrate an alternate method of using a partitioned laminating jacket 100′, which is similar to the partitioned laminating jacket 100 of FIG. 1. The partitioned laminating jacket 100′ includes an aperture 180 through each of the illustrated receiving areas 120A′, 120B′, 120C′, 120D′. The aperture 180 is configured to provide an attachment location for coupling the laminated piece 182 (illustrated in FIG. 7) to an additional structure or substrate. The partitioned laminating jacket 100′ of FIG. 6 can include a total number of receiving areas different than the partitioned laminating jacket 100 of FIG. 1, and the dimensions of each receiving area 120A′, 120B′, 120C′, 120D′ may also differ from those of the partitioned laminating jacket 100 of FIG. 1. Otherwise, the partitioned laminating jacket 100′ of FIG. 6 is substantially identical to the partitioned laminating jacket 100 of FIG. 1, the details of which are found in the preceding description. Like reference characters are used, with the addition of an appended (′). Although illustrated and described as being used in an alternate method, the partitioned laminating jacket 100′ of FIG. 6 is also capable of being used according to the method described above with respect to the partitioned laminating jacket 100 of FIG. 1.

With reference to FIG. 6, an object 184 is inserted into the first receiving area 120A′ along the direction of arrow 188. In the illustrated embodiment, the object 184 is an identification card, and the opening 180 is configured to receive a convenient attachment clip (not shown), but such aspects of the illustrated embodiment are only exemplary. The first receiving area 120A′ is separated from the partitioned laminating jacket 100′ along the edges 138′, 150′ of the perforations 130′, 134′. The individual receiving area 120A′ with the object 184 is then laminated in a laminating machine without the rest of the partitioned laminating jacket 100′, which may be wholly or sequentially used to laminate further objects at a later time. The object 184 can be inserted into the receiving area 120A′ before or after the receiving area 120A′ is separated from the partitioned laminating jacket 100′, but in either instance, this method differs from that illustrated in FIG. 5 (wherein the partitioned laminating jacket 100 is filled with objects 176 before being laminated as a whole) by providing that one or more of the receiving areas 120A′, 120B′, 120C′, 120D′ is separated and used in a laminating machine without the remainder of the partitioned laminating jacket 100′.

As described above and illustrated by FIGS. 6 and 7, the method of using only a portion of the partitioned laminating jacket 100′ at one time can be particularly useful in some instances, not limited to the making of identification cards. Such a method can also be used with the partitioned laminating jacket 100 of FIG. 1 when a number less than or not divisible by the number of receiving areas 120A-H provided in the partitioned laminating jacket 100 are needed. Furthermore, the partitioned laminating jackets 100, 100′ of FIGS. 1 and 6 can be partitioned prior to laminating when the laminating is to occur in a laminating machine that cannot receive the entire partitioned laminating jacket 100, 100′. Also, as an alternative to the illustrated flat sheet form, the partitioned laminating jackets 100, 100′ can be produced, stored, and/or used in elongated, wound rolls for convenience.

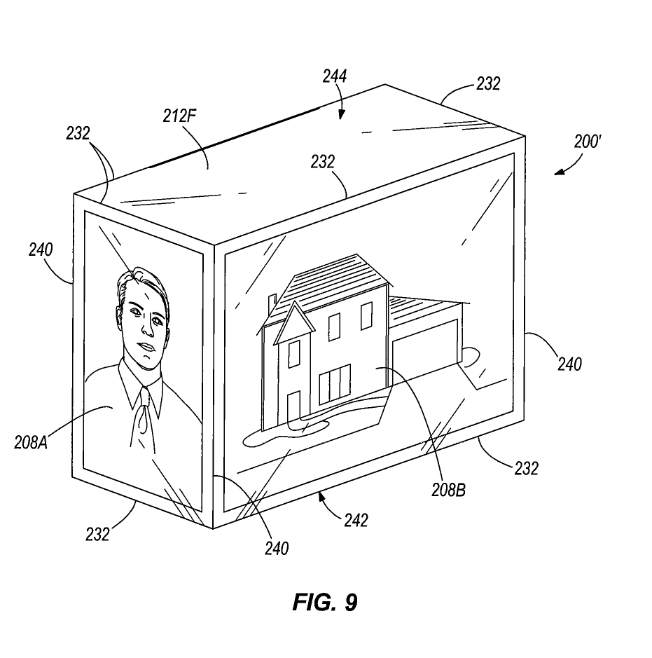

FIGS. 8 and 9 illustrate a partitioned laminating jacket 200 of another embodiment of the invention. As shown in FIG. 8, the partitioned laminating jacket 200 includes a group of receiving areas 204A-D, which are configured to receive objects 208A, 208B (FIG. 9) via respective openings 210A-D. The partitioned laminating jacket 200 of FIG. 8 includes not only the receiving areas 204A-D, but also lower flaps 212A-D, upper flaps 212E-G, and a side flap 212H. The flaps 212A-H are configured to interact so that the partitioned laminating jacket 200 can be formed into a three-dimensional laminated piece 200′ (FIG. 9) as described in further detail below.

The partitioned laminating jacket 200 includes primary pre-formed seams 216A, 216B and secondary pre-formed seams 220A-E arranged as shown in FIG. 8. The primary pre-formed seams 216A, 216B are substantially parallel to each other and span the partitioned laminating jacket 200 along a pair of primary axes 222A, 222B. The secondary pre-formed seams 220A-E are substantially parallel to each other and span the partitioned laminating jacket 200 along secondary axes 224A-E, which are substantially perpendicular to the primary axes 222A, 222B. With the exception of the flaps 212A-H and the general arrangement of both the receiving areas 204A-D and the seams 216A-B, 220A-E, the construction of and method of manufacturing the partitioned laminating jacket 200 are generally similar to that of the partitioned laminating jacket 100 of FIG. 1, described above.

A row of perforations 228 extends centrally along each of the primary pre-formed seams 216A, 216B, defining parallel primary edges 232. A row of perforations 236 extends centrally along each of a majority of the secondary pre-formed seams 220B-E, defining parallel secondary edges 240. The perforations 228, 236 divide the respective primary and secondary preformed seams 216A-B, 220B-E into seam portions associated with the respective receiving areas 204A-D and flaps 212A-G similar to the manner in which the perforations 130, 134 of FIGS. 1 and 1A divide the first and secondary pre-formed seams 104, 112B-D into respective first seam portions 142, 154 and second seam portions 146, 158.

As illustrated, the receiving areas 204A-D have varying dimensions. A first receiving area 204A and a third receiving area 204C have similar dimensions, while a second receiving area 204B and a fourth receiving area 204D share similar dimensions that are different from those of the first and third receiving areas 204A, 204C. Likewise, the first object 208A has different dimensions from the second object 208B. Furthermore, the first object 208A is smaller than the first and third receiving areas 204A, 204C, and the second object 208B is smaller than the second and fourth receiving areas 204B, 204D. This creates an enlarged border or matting effect when the partitioned laminating jacket 200 is laminated with the objects 208A, 208B inside the receiving areas 204A-D. However, objects up to a size entirely filling the receiving areas 204A-D can be used, similar to what is shown in FIG. 5.

The perforations 228, 236 of the partitioned laminating jacket 200 of FIG. 8 are configured to enable controlled bending and creasing of the partitioned laminating jacket 200 along the primary and secondary edges 232, 240 so that each of the receiving areas 204A-D occupies a different plane (see FIG. 9). In the illustrated embodiment of FIGS. 8 and 9, the partitioned laminating jacket 200 includes four receiving areas 204A-D, with adjacent receiving areas 204A-D being configured to be oriented at 90-degree angles with each other. As illustrated in FIG. 9, the partitioned laminating jacket 200 is configured to form the closed-form laminated piece 200′, which generally has a box shape (rectangular cross-section). The layout and arrangement of the partitioned laminating jacket 200 can be easily altered to provide a three-dimensional laminated piece 200′ having a cross-sectional shape that is triangular, pentagonal, hexagonal, etc.

Because the partitioned laminating jacket 200 is configurable as a three-dimensional laminated piece 200′ (after laminating in a laminating machine), a method of using the partitioned laminating jacket 200 varies from that described above with respect to the partitioned laminating jackets 100, 100′ of FIGS. 1 and 6. Prior to insertion of the partitioned laminating jacket 200 into a laminating machine (not shown), objects 208A, 208B are inserted through the openings 210A-D into the respective receiving areas 204A-D. The partitioned laminating jacket 200 and the objects 208A, 208B are inserted into the laminating machine where an adhesive between layers of the partitioned laminating jacket 200 is activated by pressure and/or heat. The adhesive is operable to bond layers of the partitioned laminating jacket 200 and the objects 208A, 208B in the laminating machine, and the openings 210A-D become closed. The results of the laminating process are similar to those described in detail above in connection with the partitioned laminating jacket 100 of FIG. 1. As briefly discussed above, the areas surrounding each of the objects 208A, 208B form a decorative border or matting.

After being laminated in the laminating machine, the partitioned laminating jacket 200 is foldable into the laminated piece 200′ shown in FIG. 9. The perforations 228, 236 allow the partitioned laminating jacket 200 to be folded and creased along the primary and secondary edges 232, 240. The perforations 228, 236 serve as guides along which the partitioned laminating jacket 200 can be creased without affecting the quality of the bond between the layers of the partitioned laminating jacket 200. Typically, bonded layers of a laminating jacket without perforations (such as the perforations 228, 236 illustrated in FIG. 8) are particularly susceptible to undesirable cracking, splitting, etc. when creased. The partitioned laminating jacket 200 can be creased along each of the secondary edges 240 defined by the secondary rows of perforations 236 (along the corresponding axes 224B-E). The side flap 212H can be tucked inside and attached adjacent the free side edge of the partitioned laminating jacket 200 (leftmost edge of FIG. 8). The bottom flaps 212A-D are creased at the lower primary edge 232 along the axis 222B and folded together with each other to form a base 242. The upper flaps 212E-G are creased at the upper primary edge 232 along the axis 222A and folded together with each other to form a closed top 244. A tab 248 of the second upper flap 212F is folded and creased along an additional row of perforations 250 to facilitate securing of the upper flaps 212E-G together as shown in FIG. 9. Thus, the laminated piece 200′ is self-standing and can be used to display the objects 208A, 208B, which are viewable from multiple different angles around the laminated piece 200′. As illustrated in FIG. 9, the laminated piece 200′ can be used as a picture display box.

The perforations 228, 236 in the partitioned laminating jacket 200 can be substantially identical to the perforations 130, 134 in the partitioned laminating jacket 100 of FIG. 1 (i.e., substantially the same aperture length S1 and spacing S2). Therefore, it is contemplated that the partitioned laminating jacket 100 of FIG. 1 can be folded along the edges 138, 150, and the partitioned laminating jacket 200 of FIG. 8 can be separated along the edges 232, 240. However, as described above, each of the partitioned laminating jackets 100, 200 are particularly suited to one method of use or the other. The perforations 130, 134 of the partitioned laminating jacket 100 of FIG. 1 and the perforations 228, 236 of the partitioned laminating jacket 200 of FIG. 8 being substantially identical simplifies the perforating equipment and processes, which may be the same regardless of whether the partitioned laminating jacket 100, 200 is configured to be separated or folded/creased. In some embodiments, the perforations 130, 134 of the partitioned laminating jacket 100 of FIG. 1 and the perforations 228, 236 of the partitioned laminating jacket 200 of FIG. 8 have different arrangements (i.e., aperture length and spacing) that are particularly suited to one or the other of separation and folding/creasing and/or particularly suited to material type, material thickness, etc.

Although not explicitly illustrated, the partitioned laminating jackets 100, 100′, 200 of FIGS. 1, 6, and 8 can include one or more scribe lines or other edge-defining structure(s) in place of the perforations 130, 134, 130′, 134′, 228, 236 that provide a locally-weakened edge, thereby enabling folding/creasing and/or tool-free separation.

Thus, the invention provides, among other things, a partitioned laminating jacket having pre-formed seams defining multiple receiving areas. Various features and advantages of the invention are set forth in the following claims.

What is claimed is:

1. A partitioned laminating jacket comprising:
a first layer;
a second layer bondable with the first layer in a laminating machine;
an adhesive between the first layer and the second layer operable to bond the first layer and the second layer in the laminating machine;
an intermediate space defined between the first layer and the second layer; and
a seam substantially spanning the partitioned laminating jacket along a first axis, the first layer and the second layer being bonded along the seam, the intermediate space being partitioned into a first receiving area and a second receiving area by the seam.

2. The partitioned laminating jacket of claim 1, wherein the adhesive is at least one of a heat-activated adhesive and a pressure-activated adhesive.

3. The partitioned laminating jacket of claim 1, further comprising a plurality of perforations extending along the seam, the plurality of perforations defining an edge.

4. The partitioned laminating jacket of claim 3, wherein the plurality of perforations facilitate separation of the first receiving area and the second receiving area along the edge, leaving the seam intact.

5. The partitioned laminating jacket of claim 3, wherein the edge divides the seam into a first seam portion associated with the first receiving area and a second seam portion associated with the second receiving area.

6. The partitioned laminating jacket of claim 3, wherein the first receiving area and the second receiving area are separable along the edge prior to lamination in the laminating machine.

7. The partitioned laminating jacket of claim 3, wherein the first receiving area and the second receiving area are separable along the edge after lamination in the laminating machine.

8. The partitioned laminating jacket of claim 3, wherein the plurality of perforations facilitate creasing the partitioned laminating jacket along the edge, leaving the seam intact.

9. The partitioned laminating jacket of claim 8, further comprising a plurality of flaps, wherein the laminating jacket is configurable in a three-dimensional shape, and wherein the plurality of flaps are configured to be secured with one another when the laminating jacket is in the three-dimensional shape.

10. The partitioned laminating jacket of claim 1, further comprising a secondary seam substantially spanning the partitioned laminating jacket along a second axis substantially perpendicular to the first axis.

11. The partitioned laminating jacket of claim 10, wherein the seam along the first axis divides the partitioned laminating jacket into a first row having at least two receiving areas separated by the secondary seam and a second row having at least two receiving areas separated by the secondary seam.

12. The partitioned laminating jacket of claim 11, wherein the at least two receiving areas of the first row include openings facing a first direction and the at least two receiving areas of the second row include openings facing a second direction, the second direction being oriented 180 degrees from the first direction.

13. A method of creating laminated objects comprising the steps of:
providing a partitioned laminating jacket having a first pre-formed seam extending substantially across the partitioned laminating jacket, the first pre-formed seam at least partially defining a first receiving area and a second receiving area;
inserting a first object into the first receiving area;
inserting a second object into the second receiving area;
inserting the partitioned laminating jacket into a laminating machine to laminate the first and second objects; and
separating the first object and a first portion of the partitioned laminating jacket from the second object and a second portion of the partitioned laminating jacket.

14. The method of claim 13, wherein the first portion and the second portion of the partitioned laminating jacket are separated prior to inserting the partitioned laminating jacket into the laminating machine.

15. The method of claim 13, wherein the first portion and the second portion of the partitioned laminating jacket are separated after inserting the partitioned laminating jacket into the laminating machine.

16. The method of claim 13, wherein the first object and the second object are inserted into the partitioned laminating jacket in opposing directions.

17. The method of claim 13, wherein separating the first portion and the second portion of the partitioned laminating jacket includes separating the partitioned laminating jacket along a first perforated edge, thereby dividing the first pre-formed seam into a first seam portion and a second seam portion.

18. The method of claim 17, wherein the first seam portion is associated with the first receiving area and the second seam portion is associated with the second receiving area.

19. The method of claim 18, wherein the partitioned laminating jacket includes a second pre-formed seam extending substantially across the partitioned laminating jacket substantially perpendicular to the first pre-formed seam, the second pre-formed seam at least partially defining a third receiving area adjacent the first receiving area, the method further comprising inserting a third object into the third receiving area, the first object and the third object being inserted into the partitioned laminating jacket in the same direction.

20. The method of claim 19, further comprising separating the third object and a third portion of the partitioned laminating jacket from the first object and the first portion of the partitioned laminating jacket along a second perforated edge.

21. A method of creating a three-dimensional laminated piece comprising the steps of:
providing a partitioned laminating jacket having a pre-formed seam extending substantially across the partitioned laminating jacket, the pre-formed seam at least partially defining a first receiving area and a second receiving area;
providing a weakened edge along the pre-formed seam inserting a first object into the first receiving area;
inserting a second object into the second receiving area;
inserting the partitioned laminating jacket into a laminating machine to laminate the first and second objects; and
creasing the partitioned laminating jacket along the weakened edge to form the partitioned laminating jacket into a three-dimensional shape.
